(19) United States
(12) Patent Application Publication
(10) Pub. No.: US 2007/0278846 A1
(43) Pub. Date: Dec. 6, 2007

(54) Tire sidewall protecting cover

(76) Inventor: Vance S. Fleming, Auberry, CA (US)

Correspondence Address: RICHARD A. RYAN;ATTORNEY AT LAW, 8497 N. MILLBROOK AVENUE, SUITE 101, FRESNO, CA, 93720, US

(21) Appl. No.: 11/809,144

(22) Filed: May 31, 2007

Related U.S. Application Data
(60) Provisional application No. 60/810,325, filed on Jun. 2, 2006.

(51) Int. Cl. B60B 7/00

(52) U.S. Cl. 301/37.104; 301/37.34

(57) ABSTRACT

A tire sidewall protecting cover configured to protect the sidewalls of a vehicle tire. The tire cover comprises a cover body having an exterior surface that defines a front panel, side panel and rear panel. The cover body is sized and configured to extend generally over the sides and the front of the tire and at least partially down the rear of the tire. Attached to the cover body is a securing flap that is placed under the tire by moving the vehicle slightly forward or backward on top of the securing flap. In a preferred embodiment, the securing flap attaches to the front panel and extends inwardly under the tire to prevent the tire cover from blowing off or being stolen. A strengthening means, such as a stronger seam, wires or wire mesh, interconnects the securing flap and front panel to further prevent unauthorized removal of the tire cover.

### CROSS-REFERENCE TO RELATED APPLICATIONS

This application claims priority to U.S. Provisional Patent Application No. 60/810,325 file Jun. 2, 2006.

### BACKGROUND OF THE INVENTION

A. Field of the Invention

The field of the present invention relates generally to apparatuses that are configured as a tire and wheel cover to provide protection for a mounted tire on a parked vehicle. More particularly, this invention relates to such protective covers that are configured to protect the outward facing surfaces of the tire and wheel from damage or degradation caused by rain, snow and other weather conditions, ultraviolet rays, dirt, dust and other harmful substances. Even more particularly, this invention relates to such protective tire covers that are configured to be relatively easy to install yet difficult to steal or be dislodged by the wind.

B. Background

One of the most important features for the safe operation of a motor vehicle, including automobiles, trucks and recreational vehicles, is the vehicle's tires. Recent press coverage of vehicle tire problems has raised the public awareness of the importance that tire safety plays in the operation of almost any type of motor vehicle. With proper care and maintenance, the tires of a vehicle can provide a wide margin of safety in terms of wear and durability. It is well known that key factors to ensuring both tire safety and long tire life include maintaining proper air pressure and monitoring tread wear. An often overlooked set of factors that are crucial to how long a set of tires lasts and, consequently, the degree of safety that a set of tires add to the driveability of a vehicle is how well the tires are protected from the degrading effects of the environment, including rain, snow and other weather conditions, UV rays from the sunlight, dirt and dust. These and other environmental factors can cause just as much damage, if not more under certain circumstances, than road wear. To resist such damage, conventional tires are typically manufactured with a wax compound that acts as a barrier between the tire polymer and ozone in the air. During normal usage, the protective wax migrates to the surface of the tire to form the protective barrier. When the tire is not used for and extended time, such as when a vehicle is parked for storage, the wax does not migrate, leaving the tire polymer exposed to the damaging effects of ozone and UV rays. As a result, the damaging effects of the environment are somewhat exacerbated for the tires of vehicles that are parked or stored for long periods of time.

Typically, recreational vehicles are driven for relatively brief periods of time, such as for vacations and the like, and are kept for long periods of time in storage or parked in either a parking lot or on the street when not in use. Consequently, unless the vehicle is stored in a protected area such as an enclosed garage, the tires are specially vulnerable to the damage that results from the exposure to the elements. Because tires are constructed from rubber and petroleum compounds, all tires will eventually exhibit some type of cracking or other forms of wear due to use, which can be accelerated by exposure to heat, vehicle exhaust, ozone and sunlight. The tires of a vehicle parked out of doors, instead of inside of a protected garage, will be exposed to the rays of the sun, thereby increasing the likelihood of damage from cracking and drying. Generally, when exposure to sunlight is the cause of tire degradation, it is the sidewall of the tire facing outward that exhibits the most damage, while the sidewall facing inward is typically significantly less affected. Further problems can develop from exposure of the tires to water or other forms of moisture, which often results in mildew and/or rot that can also degrade the rubber in the tires. Still further tire degradation occurs due to the abrasive quality of blowing dust, sand and soil. Ideally, creating an environment where the tire is kept free from as much of these damaging factors as possible, such as the conditions typically found inside of a darkened garage, is the best method for preserving the useful life of a tire. For many owners of recreational vehicles or other types of vehicles that are frequently parked for extended periods of time, however, the ability to provide an indoor or otherwise protective storage space is usually not feasible due to factors of cost and/or space limitations. Nonetheless, the optimal method for protecting the tires of such a vehicle is one that replicates as closely as possible the conditions found in a clean and darkened garage. An ideal tire protection device should shield the outer surface of the tire, that being the tire surface most exposed to the elements, from the UV rays of the sunlight, rain and other weather elements, and from the ozone in order to limit the degradation of the composite materials of the tire.

A number of tire and wheel covers have been developed to protect a tire from the harmful conditions described above. For example, U.S. Pat. No. 6,044,968 to Lampen describes a tire protective cover for covering and protecting a static mounted tire. The tire cover includes a resilient casing that covers one side of a tire and consists of a series of sequentially raised concentric surfaces that substantially forms a cone that fits over the surface of the tire. The cover is secured to the tire with a resilient fastener, such as a bungee cord, that is looped around the body of the tire. U.S. Pat. No. 2,073,845 to Lyon describes a tire cover consisting of a one piece tire cover constructed so that it can flex to stretch around the tire so as to completely cover the outer sidewall of the tire, most specifically a spare tire mounted on the rear bumper of a vehicle. The cover is secured to the tire with a series of straps and a locking means to serve as an anti-theft device. In addition to the above patented devices, current examples of tire covers specific to recreational vehicles on the market are tire covers, such as Adco Tyre Guards, comprising a heavy duty vinyl cover that slips over the outer face of the tire and is secured thereto with a series of reinforced brass grommets to cinch an elastic type cord around the base of a wheel.

While these types of tire covers generally provide protection from the damaging UV rays and other harmful attributes of the elements, they do pose some challenges for the user. Most notably, they can be awkward or difficult to secure to a tire, necessitating the user to kneel on the ground and to reach around to the rear of the wheel to secure the cords through the grommets. This can pose significant challenges for the user, especially in inclement weather or on surfaces that are muddy or otherwise inconvenient. One segment of the population for who recreational vehicles are especially popular are senior citizens. For this group, securing tire covers that require the user to reach around the wheel to apply the cover can be especially difficult. The inherent inconvenience of a difficult application process where the user needs to kneel or crawl under the vehicle to reach behind the tire to secure the cover can cause individuals not to use the tire cover, thereby risking damage to their tires that can result in blow-outs or other driving dangers.

A problem associated with tire covers that merely slip over the front face of the tire without a mechanism to secure the tire cover to the tire is that the cover can be blown off with the wind. To exacerbate this problem, if a vehicle is parked for storage, the owner is often not present to check the cover or to replace it if it has blown off, resulting in a tire that is exposed to the elements, completely undermining the utility of the tire cover. Theft or vandalism poses another serious problem as well. Most tire covers are a substantial investment for the vehicle owner, requiring one for each tire. A tire cover that is simply slipped over the front face of a tire is easily removed by a thief and a tire cover that is merely secured with a bungee or otherwise elastic cord is easily stolen by cutting the cord or cutting the cover. As a result, in addition to exposing the tire to the damaging effect of the elements, the owner must also incur the additional expense of replacing the tire covers.

What is needed, therefore, is a tire cover for a vehicle tire that is configured to be sturdy, lightweight, protective and which can be easily applied to and removed from the tire by the vehicle owner while being difficult for a thief or other unauthorized person to steal or for the wind or other elements to dislodge from the tire. The preferred tire cover should fully cover the outward facing plane of the tire so as to protect the tire from the damaging effects of UV rays, moisture, dirt, dust and other hazards that can damage or cause undue wear to a tire. The preferred tire cover should be easy to install over the exposed side of the tire and secure to the vehicle for individuals with a diverse range of physical abilities (i.e., wherein the user does not need to kneel on the ground or reach under the vehicle to secure the cover to the vehicle).

### SUMMARY OF THE INVENTION

The tire cover of the present invention provides the benefits and solves the problems identified above. That is to say, the present invention discloses an improved tire cover that is configured to be used with a wide variety of vehicle tires, such as those used on recreational vehicles, classic or antique cars, trucks and commercial vehicles, particularly those parked or stored outside for long periods of time. The present invention provides protection from the harmful UV rays as well as rain, dust and soil, by providing a durable waterproof barrier that fits over the sidewall, top and front portions of the tire. The tire sidewall protecting cover of the present invention is configured for the user to easily anchor the cover to the vehicle so as to substantially prevent theft of the cover or the wind dislodging the cover.

In one general aspect of the present invention, the tire sidewall protecting cover generally comprises a cover body having an exterior surface with a top and a bottom side. The cover body defines a front, side and rear panels. The cover body is sized and configured to fit over and substantially around at least the front and sides of a vehicle tire. In the preferred embodiment, the rear panel extends only partially down the height of the vehicle tire so it does not contact the vehicle's axle. Preferably, the cover body is made from a generally durable, lightweight and pliable material so that it will last long in the outdoor conditions in which it is normally used and for ease of putting the tire cover on and removing it from the vehicle tire. To prevent loss of the tire cover due to wind or theft, the tire cover has a securing flap that, in the preferred embodiment, is attached to the bottom of the front panel and extends inwardly toward the vehicle tire to be received under the vehicle tire so the weight of the vehicle at the tire can secure the tire cover to the tire. In one of the preferred embodiments, the tire cover also includes a strengthening mechanism that interconnects the front panel and the securing flap to more securely attach the securing flap to the front panel. Preferably the strengthening mechanism is configured to further reduce loss due to wind and is configured and/or made out of materials that make it difficult to cut the securing flap with a knife, scissors or other standard cutting tools. In one embodiment, the strengthening mechanism is a strengthened seam where the securing flap joins the front panel. In another embodiment, the strengthening mechanism is one or more non-cut members, such as elongated wire members or a wire mesh. In use, the user places the tire cover over the vehicle tire, with the tire received in the envelope formed by the front, side and back panels and with the front panel facing away from the tire. The tire cover is slightly angled on the vehicle tire such that the securing flap is positioned slightly behind the vehicle tire or slightly in front of the vehicle tire. The user then either backs up or moves forward slightly, as is appropriate depending on the position of the securing flap, to roll the tire on top of the securing flap. The weight of the vehicle at the tire will prevent the wind or a thief from removing the tire cover from the vehicle tire until the vehicle is moved, slightly, to take the weight off of the securing flap and allow the tire cover to be removed from the tire.

Accordingly, the primary objective of the present invention is to provide a tire cover that provides the advantages discussed above and overcomes the disadvantages and limitations associated with presently available covers for vehicle tires.

It is also an important object of the present invention to provide a tire sidewall protecting cover that is configured to be secured to the vehicle tire without the need for external or accessory locking devices.

It is also an important object of the present invention to provide a tire sidewall protecting cover that includes a securing flap that it attached to the tire cover body and which extends under the tire so that the weight of the vehicle at the tire prevents loss or theft of the tire cover.

It is also an important object of the present invention to provide a tire sidewall protecting cover that has a securing flap attached to the tire cover body and a strengthening mechanism interconnecting the flap and the cover body to further prevent loss or discourage theft of the tire cover.

The above and other objectives of the present invention will be explained in greater detail by reference to the attached figures and the description of the preferred embodiment which follows. As set forth herein, the present invention resides in the novel features of form, construction, mode of operation and combination of processes presently described and understood by the claims.

### BRIEF DESCRIPTION OF THE DRAWINGS

In the drawings which illustrate the preferred embodiments and the best modes presently contemplated for carrying out the present invention:

FIG. 1 is a side view of a vehicle with a tire sidewall protecting cover configured according to a preferred embodiment of the present invention shown in use on a tire of the vehicle;

FIG. 2 is a front view of the tire sidewall protecting cover of the present invention shown in use on a tire (the tire being shown with a hidden line);

FIG. 3 is a side perspective view of the tire sidewall protecting cover of the present invention shown in use on a tire, with the side panel of the tire cover removed, showing use of a strengthened seam;

FIG. 4 is a front perspective view of the tire sidewall protecting cover of the present invention showing the use of a plurality of wires to discourage theft of the tire cover;

FIG. 5 is a back view of the tire cover of the FIG. 4; and

FIG. 6 is a front perspective view of an alternative embodiment of the tire sidewall protecting cover of the present invention showing the use of a wire mesh to discourage theft of the tire cover.

### DETAILED DESCRIPTION OF THE PREFERRED EMBODIMENTS

With reference to the figures where like elements have been given like numerical designations to facilitate the reader's understanding of the present invention, the preferred embodiments of the present invention are set forth below. The enclosed figures and drawings are merely illustrative of a preferred embodiment and, as such, represent one of several different ways of configuring the present invention. Although specific components, materials, configurations and uses are illustrated, it should be understood that a number of variations to the components and to the configuration of those components described herein and in the accompanying figures can be made without changing the scope and function of the invention set forth herein. For instance, although the figures and description provided herein are primarily directed to use of the tire sidewall protecting cover with a recreational vehicle or the like, those skilled in the art will readily understand that this is merely for purposes of simplifying the present disclosure and that the present invention is not so limited. For instance, the present invention may be equally applicable for use with tires on a wide variety of different vehicles.

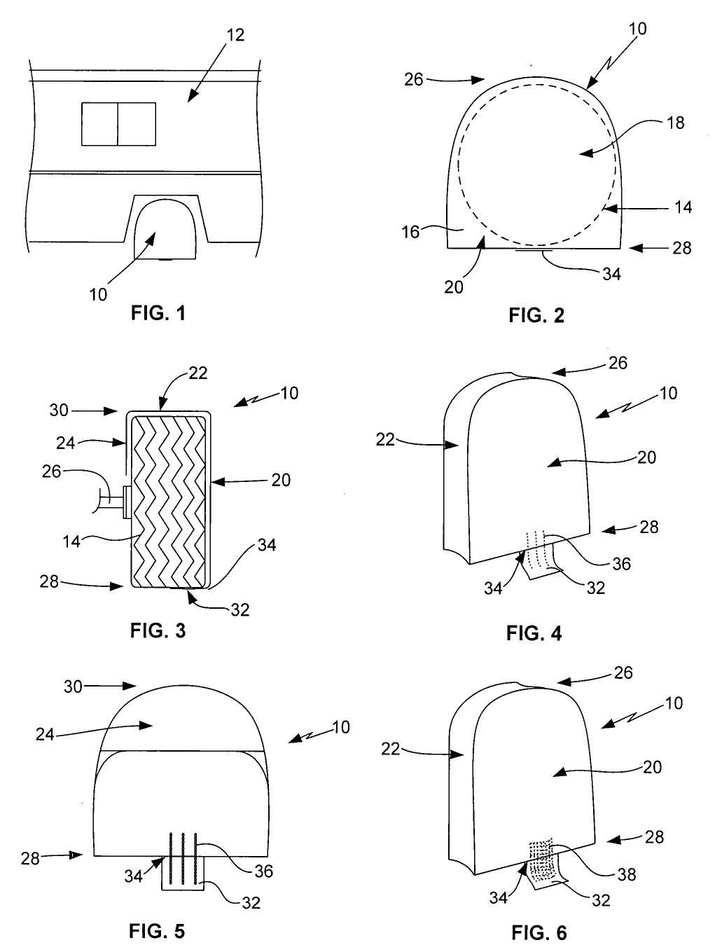

An improved tire sidewall protecting cover that is manufactured out of the components and configured pursuant to a preferred embodiment of the present invention is shown generally as 10 in the figures. Tire cover 10 is configured to be utilized with a parked or otherwise stationary vehicle 12, such as the recreational vehicle or RV shown in FIG. 1, to cover and protect the vehicle tire 14 from damage due to rain, snow, UV rays, dirt, dust and a variety of other environmental effects. In a preferred embodiment, tire cover 10 generally comprises a cover body 16 having an exterior surface 18 defining a front panel 20, a side panel 22 and rear panel 24, as best shown in FIGS. 3 through 5. The front panel 20 is the side of the tire cover 10 that is facing outward from vehicle 12 and is sized and configured to cover the tire 14 from its top to its bottom, as shown in FIG. 2. Often the exterior surface 18 of front panel 20 will have a vehicle logo, design, advertisement or other information thereon. The side panel 22 is attached to or integral with front panel 20 and extends from the bottom 28 at one side of tire cover 10 across the top 30 and down the other side to the bottom 28 of tire cover 10. The width of side panel 22 should be sufficient to extend across the width of tire 14. Rear panel 24 is attached to or integral with the upper section of side panel 22 and extends downwardly from the top 30 of cover body 16 along a portion of the back side of the tire 14 toward the axle 26 of vehicle 12, as best shown in FIGS. 3 and 5. Generally, as shown in these figures, it is preferred that rear panel 24 not extend all of the way down the back side of tire 14 against the axle 26. As best shown in FIGS. 1 and 2, the tire cover 10 is positioned on tire 14 such that the rear panel 24 and the side panel 22 are placed over the top surface of tire 14 to form a secure and structurally stable envelope covering the surface of tire 14, including the otherwise exposed sidewall, and the vehicle wheel.

As those skilled in the manufacture of automotive accessories will recognize, the tire cover 10 can be manufactured from a wide variety of materials that are suitable to provide tire 14 with the needed protection from UV rays, rain and abrasives. Preferably, tire cover 10 is made out of material that is sufficiently durable so as to provide a strong, long lasting cover. In a preferred embodiment, the cover body 16 can be manufactured out of a strong vinyl or similar material that can be fabric-backed, such as with felt or a similar material to help prevent slippage as the present invention 10 is applied to tire 14. An example of such a material includes a high-performing synthetic material such as a laminated fabric, an example of which is Herculite®, or other such material. Such fabrics provide the necessary durability to protect the tire from a wide array or environmental hazards, including sunlight, moisture and dirt. In addition, such durable fabrics also provide a tire cover 10 that is generally lightweight and pliable, which are important to obtain a tire cover 10 that is easy to apply to and remove from tire 14, as well as to be manipulated for foldability and storage.

The above description generally describes conventional, prior art tire sidewall protecting covers that are well known in the art. The improvement to the tire cover 10 of the present invention is the addition of a securing flap 32, best shown in FIGS. 3 through 5. In the preferred embodiment, securing flap 32 is a generally planar panel extension or flap-like member that is attached to the bottom 28 of tire cover 10 so as to extend under the tire 14 when in use, as best shown in FIG. 3. As explained in more detail below, the weight of the vehicle 12 at tire 14 on securing flap 32 will secure the tire cover 10 over tire 14 so as to generally prevent or reduce the likelihood that a thief or the wind will be able to remove tire cover 10 from tire 14. Preferably, tire cover 10 includes a means for strengthening the attachment of securing flap 32 to cover body 16. In one embodiment, the strengthening means is a strengthened seam, shown as 34, that more securely attaches securing flap 32 to cover body 16 so as to deter a would be thief tearing, ripping or cutting tire cover 10 or the wind tearing tire cover 10 at the seam to remove or dislodge securing flap 32 from cover body 16. To better prevent tire cover 10 from being removed by a thief or the wind, a preferred embodiment of the strengthening means for tire cover 10 is one or more non-cut members 36 in securing flap 32 that extend across seam 34 into cover body 16, as shown in FIGS. 4 and 5. Non-cut members 36 can comprise one or more elongated members, which can be wire or wire-like elements, that are made out of material which is difficult to tear, cut or otherwise separate with the hands or by using a knife, scissors or other cutting tool. Alternatively, the non-cut members 36 can comprise a wire mesh, shown as 38 in FIG. 6, that is difficult to tear, cut or otherwise separate with the hands or by using a knife, scissors or other common cutting tool. The use of non-cut members 36 prevents a would-be thief from merely cutting tire cover 10 across securing flap 32 or through the front panel 20 of cover body 16 in order to remove tire cover 10 from tire 14. Additionally, the use of non-cut members 36 strengthens and better secures tire cover 10 from being blown off tire 14 by the wind.

To install tire cover 10, the user places tire cover 10 over tire 14 as he or she would a standard, non-secured tire cover except with the cover body 16 slightly tilted to place securing flap 32 either slightly ahead or behind the tire. This is repeated for all tires 14 the user wishes to protect against the elements, typically either two or four tires 14. Securing flap 32 is unfolded such that it extends inward towards the vehicle 12. If the securing flap 32 of each tire cover 10 is behind the tire 14, then the user backs of the vehicle 12 a slight amount to place the weight at tire 14 on top of securing flap 32. If the securing flap 32 of each tire cover 10 is ahead of the tire 14, then the user moves vehicle 12 forward a slight amount to place the weight at tire 14 on top of securing flap 32. In this manner, securing flap 32 is held down by tire 14, as best shown in FIG. 3, thereby preventing a would-be thief or the wind from easily removing tire cover 10 from tire 14. To remove tire cover 10 of the present invention 10 from tire 14, the process for installing tire cove 10 is merely reversed. Namely, the user either backs up vehicle 12 or moves it forward a slight amount to take the weight of tire 14 off of securing flap 32. Once the weight is off securing flap 32, the user will remove tire cover 10 from tire 14 as he or she would a standard tire cover. As those skilled in the art of tire covers will recognize, to enhance the attractiveness and the utility of tire cover 10 of the present invention, a preferred embodiment of the present invention will emphasize the ease of storage of tire cover 10 wherein the entire tire cover 10 can be conveniently folded or otherwise manipulated for storage when not in use. If desired, tire cover 10 can be placed in a storage bag or other device for storage.

While there are shown and described herein a specific form of the invention, it will be readily apparent to those skilled in the art that the invention is not so limited, but is susceptible to various modifications and rearrangements in design and materials without departing from the spirit and scope of the invention. In particular, it should be noted that the present invention is subject to various modifications with regard to any dimensional relationships set forth herein and modifications in assembly, materials, size, shape, and use. For instance, there are numerous components described herein that can be replaced with equivalent functioning components to accomplish the objectives of the present invention. One such modification is the use of different materials than those set forth herein.

What is claimed is:

1. A tire cover for use to cover a vehicle tire, said tire cover comprising:
a cover body having an exterior surface defining a front panel, a side panel and a rear panel, said cover body sized and configured to fit over and substantially around at least the front and sides of the vehicle tire; and
a securing flap attached to at least one of said front panel, said side panel and said rear panel, said securing flap configured to extend under the vehicle tire to secure said tire cover to the vehicle tire.

2. The tire cover according to claim 1, wherein said securing flap is attached to said front panel and said securing flap extends inwardly toward the vehicle tire.

3. The tire cover according to claim 2 further comprising a strengthening means interconnecting said front panel and said securing flap for more securely attaching said securing flap to said front panel.

4. The tire cover according to claim 3, wherein said strengthening means is a strengthened seam.

5. The tire cover according to claim 3, wherein said strengthening means is one or more non-cut members.

6. The tire cover according to claim 5, wherein said non-cut members include one or more elongated wire members.

7. The tire cover according to claim 5, wherein said strengthening means is a wire mesh.

8. The tire cover according to claim 1 further comprising a strengthening means interconnecting said cover body and said securing flap for more securely attaching said securing flap to said cover body.

9. The tire cover according to claim 8, wherein said strengthening means is a strengthened seam.

10. The tire cover according to claim 8, wherein said strengthening means is one or more non-cut members.

11. The tire cover according to claim 1, wherein said cover body is made from a generally lightweight and pliable material.

12. A tire cover for use to cover a vehicle tire, said tire cover comprising:
a cover body having an exterior surface with a top and a bottom, said cover body defining a front panel, a side panel and a rear panel, said cover body sized and configured to fit over and substantially around at least the front and sides of the vehicle tire, said rear panel extending only partially down the height of the vehicle tire; and
a securing flap attached to the bottom of said front panel, said securing flap configured to extend generally inwardly from said front panel and be placed under the vehicle tire to secure said tire cover to the vehicle tire.

13. The tire cover according to claim 12 further comprising a strengthening means interconnecting said front panel and said securing flap for more securely attaching said securing flap to said front panel.

14. The tire cover according to claim 13, wherein said strengthening means is a strengthened seam.

15. The tire cover according to claim 13, wherein said strengthening means is one or more non-cut members.

16. The tire cover according to claim 15, wherein said non-cut members include one or more elongated wire members.

17. The tire cover according to claim 15, wherein said strengthening means is a wire mesh.

18. A tire cover for use to cover a vehicle tire, said tire cover comprising: a cover body having an exterior surface with a top and a bottom, said cover body defining a front panel, a side panel and a rear panel, said cover body sized and configured to fit over and substantially around at least the front and sides of the vehicle tire;
a securing flap attached to the bottom of said front panel, said securing flap configured to extend generally inwardly from said front panel and be placed under the vehicle tire to secure said tire cover to the vehicle tire; and
a strengthening means disposed in said securing flap and said front panel, said strengthening means configured to interconnect said front panel and said securing flap for more securely attaching said securing flap to said front panel.

19. The tire cover according to claim 18, wherein said strengthening means is a strengthened seam.

20. The tire cover according to claim 18, wherein said strengthening means is one or more non-cut members.
